(19) United States
(12) Patent Application Publication
(10) Pub. No.: US 2002/0106066 A1
(43) Pub. Date: Aug. 8, 2002

(54) System and methods for providing anonymous telephone communications

(75) Inventors: Craig G. Swanson, Pasadena, CA (US); Yuri Vanetik, Lemon Heights, CA (US); Geoffrey G. Fiala, Huntington Beach, CA (US)

Correspondence Address: LYON & LYON LLP, 633 WEST FIFTH STREET, SUITE 4700, LOS ANGELES, CA, 90071, US

(73) Assignee: ONEPUB.COM

(21) Appl. No.: 09/777,309

(22) Filed: Feb. 5, 2001

(51) Int. Cl. H04M 3/00; H04M 3/42

(52) U.S. Cl. 379/196; 379/201.01

(57) ABSTRACT

A system for anonymous voice communications between members of an online community includes a server, a member database, and a switch. The server receives a call request from a first member identifying a second member. The server searches the member database for screening data associated with the second member, and the call request is validated based upon the screening data. The screening data may include a preferred member list, geographic proximity restrictions, personal or demographic preferences, and/or time restrictions, which may be compared to the profile of the first member to determine whether to authorize the call request. Once validated, a call notice is sent to the second member, identifying the first member and requesting acceptance of the call request. If accepted, telephone numbers of the members are obtained, e.g., from the member database, and the switch connects the members via a telecommunications network.

### FIELD OF THE INVENTION

The present invention relates generally to systems and methods for facilitating communication between members of online communities, and more particularly to systems and methods for providing voice communications between members of online communities, e.g., by telephone, without necessarily divulging personal contact information of the members.

### BACKGROUND

Social interaction via a network, such as the Internet, and more particularly the World Wide Web, has become increasingly popular. To facilitate communication between individuals, a variety of social communities have evolved on the Web, ranging from bulletin board services, to chat rooms, to membership-based service providers. Membership-based services, such as online “singles” or other dating services, allow members to search for other members with whom they may be interested in initiating contact. Such contact may range from simply becoming “penpals” sharing common interests to seeking long-term personal relationships.

Members of online communities may submit information on themselves that may be stored in a member database. Members may search the member database for other members to contact, e.g., based upon common interests, geographic location, physical appearance, and the like. When a first member has found a second member of interest to him/her, the first member may want to initiate contact with the second member in a manner that protects his/her privacy until the members become better acquainted with one another. Such private contact, however, is generally limited to exchanging e-mail or other typed communications, such as communicating via online chat rooms or “instant messaging.” If the members want to communicate by voice, one of the members generally has to divulge personal contact information, i.e., their telephone number, to the other. Unfortunately, this may violate the divulging member's privacy and expose them to possible undesired contact with members to whom they have previously given their personal contact information.

To protect the privacy of parties in such situations, systems have been suggested for allowing parties to engage in telephone calls with one another without divulging their telephone numbers. For example, U.S. Pat. No. 5,818,836, issued to DuVal, discloses a telephone communication system that uses match codes to connect parties anonymously. When parties decide to initiate a telephone call with one another, they may agree upon a match code and a designated time. Each of the parties then place a telephone call to a circuit switched network at the designated time, and enter the match code. The network tries to match the match code, and, if successful, connects the parties. Thus, the DuVal system requires prior coordination by the parties, and requires each of the parties to call a network at the same in order to communicate with one another.

Alternatively, the DuVal system allows one of the parties to try to initiate an anonymous telephone call by submitting a request to the system. The system sends a message to the second party whether they would like to accept the call. If the second party accepts, the system then requests information from each of the parties required to set up the call, e.g., their telephone numbers, and connects the parties. Thus, even this mode involves multiple actions by the parties before they may complete an anonymous telephone call.

Accordingly, systems and methods for facilitating voice communication between members of online communities without disclosing personal contact information of the members and/or that are more convenient to use would be considered useful.

### SUMMARY OF THE INVENTION

The present invention is directed to systems and methods for facilitating voice communications between members of online social communities, e.g., by telephone, without necessarily divulging personal contact information of the members, i.e., unless or until the members choose to do so.

In accordance with one aspect of the present invention, a system is provided that facilitates anonymous voice communications between two or more members of an online social community. The system generally includes a server, a member database accessible by the server, a validation module, and a switch. The member database includes member identifiers identifying members of the social community. The member database also includes screening data associated with respective members and voice communication addresses associated with respective members. The screening data preferably include parameters that may selected by members to restrict incoming call requests.

The server may communicate with members via an electronic network, such as the Internet. For example, the server may be configured for receiving search requests from members searching for other members satisfying one or more parameters included in the search request. The server may be connected to a search engine, which may, in turn, be connected to the member database for searching member profile data of the member database for members satisfying search requests. The server may communicate lists to members, the list identifying one or more members at least partially matching parameters of the search requests.

The server is also configured for receiving call requests from members once the members have identified other members of interest, i.e., to initiate voice communication with the members of interest. The validation module may review screening data of the members of interest, e.g., to determined whether to authorize the call requests. Once authorized, the switch may initiate voice communications between members via the voice communications network, e.g., via a conventional telecommunications network.

In accordance with another aspect of the present invention, a method is provided for initiating voice communication between first and second members of an online community using a member database, such as that described above. As explained above, a call request may be received from a first member, e.g., by a server, the call request identifying the second member. The call request may include other information, such as an identifier of the first member, a voice communication address for contacting the first member, a desired time of call, and the like.

The member database may be searched for screening data associated with the second member, and the call request may then be validated based upon the screening data. For example, the screening data may include profile preferences of the second member, and the validation module may compare the profile preferences with a member profile of the first member, e.g., using a statistical matching algorithm. The screening data may also include a preferred member list including one or more members with whom the second member is interested in engaging in voice communication. The validation module may confirm whether the first member is included in the preferred member list before authorizing a call. If the call request is from a member on the preferred member list, the server may automatically send the second member a notice that a call request has been received from a member on the preferred member list.

In addition, the screening data may include a decline list including one or more members with whom the second member refuses to engage in voice communication. The validation module may confirm whether the first member is included in the decline list. If so, the server may send a decline notice to the first member and discontinue initiating the call.

The screening data may also include geographic restriction data, and the validation module may compare geographic location data of the first member with the geographic restriction data associated with the second member. For example, the validation module may confirm that the first member lives within a geographic region sufficiently close or otherwise acceptable to the second member.

The screening data may also include a time restriction, and the validation module may confirm whether a desired time of call for the call request falls within a time restriction associated with the second member. If not, the server may send a decline notice to the first member, which may include a notice to try the call again at a different time.

Once the call request is validated, voice communication may be initiated between the second member and the first member, while withholding personal contact information of the first and second members from each another. For example, a call notice may be sent to the second member, the call notice identifying the first member, and requesting the second member to accept the voice communication. The call notice may include information related to the first member, e.g., member profile data associated with the first member and/or a photograph of the first member. Alternatively, the call notice may include an interface for accessing such information related to the first member.

If the second member accepts the call request, the switch may connect the first and second members via a voice communications network, e.g., a conventional telecommunications network. This may involve obtaining voice communication addresses for one or both of the first and second members from the member database. Alternatively, the call request itself may include the voice communication address for the first member. The switch may then use the voice communication addresses to connect the first and second members at locations identified by the voice communication addresses via the voice communications network.

Alternatively, the second member may respond with a requested call delay. The first member may wait until the requested call delay elapses, whereupon the first and second members may be connected via the voice communications network, or the first member may decline, and the call may be discontinued. If the call request is unsuccessful in resulting in a voice communication between the first and second members, e.g., if the second member fails to respond to the call request, a missed call notice may be sent to the second member. The missed call notice may include information related to the unsuccessfully attempted voice communication. The missed call notice may also include a call-back interface, allowing the second member to initiate voice communication with the first member.

Other objects and features of the present invention will become apparent from consideration of the following description taken in conjunction with the accompanying drawings.

### BRIEF DESCRIPTION OF THE DRAWINGS

For a better understanding of the invention, and to show how it may be carried into effect, reference will be made, by way of example, to the accompanying drawings, in which:

FIG. 1 is a block diagram, showing a system for facilitating anonymous voice communications between members of an online community, in accordance with the present invention.

FIG. 2 is a flowchart, showing a series of inquiries for submitting screening data for entry in a member database, in accordance with the present invention.

FIG. 3 is an exemplary interface for entering screening data to be included in a member database, in accordance with the present invention.

FIG. 4 is a flowchart, showing a method for processing a call request submitted by a first member to initiate voice communication with a second member, in accordance with the present invention.

FIG. 5 is a flowchart, showing a method for validating a call request, in accordance with the present invention.

FIG. 6 is a flowchart, showing a method for initiating a call upon validation of a call request, in accordance with the present invention.

FIG. 7 is an exemplary interface for a member receiving a call request from another member, in accordance with the present invention.

### DETAILED DESCRIPTION OF THE PREFERRED EMBODIMENTS

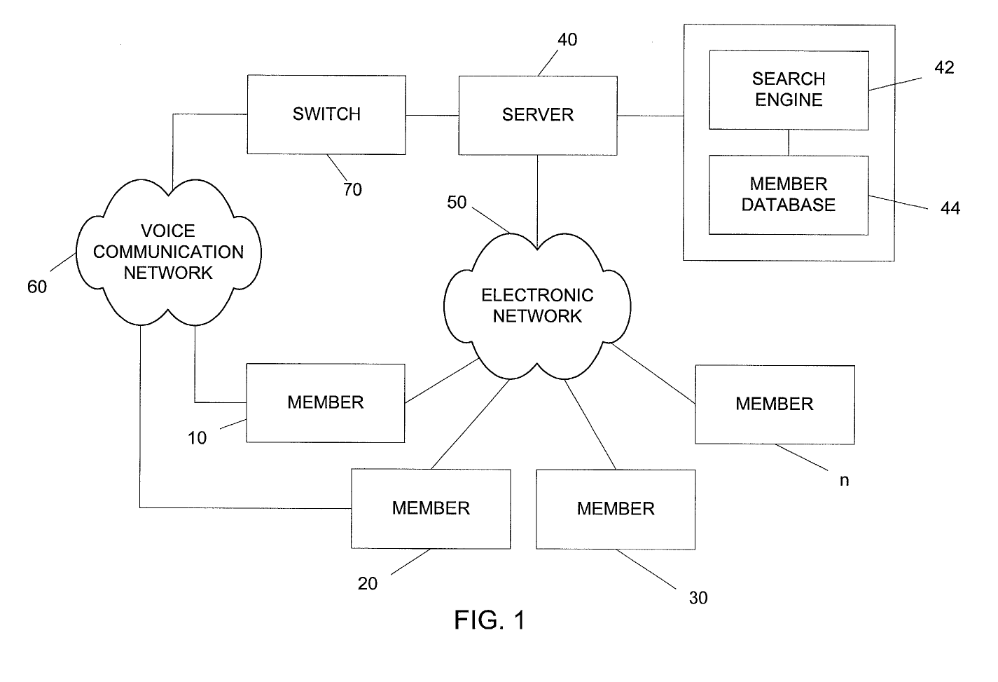

Turning now to the drawings, FIG. 1 shows a system for facilitating voice communications between members, in accordance with the present invention. A plurality of members 10, 20, 30, n are connected to a server 40 via an electronic network 50. The members 10-n generally communicate via the electronic network 50 using a computer or other electronic device (not shown) including conventional hardware and/or software components. The server 40 is connected to a search engine 42 and a member database 44, which are configured for compiling, storing, and/or retrieving information related to the members 10-n. Alternatively, a plurality of servers and/or databases (not shown) may be connected to one another either directly or via the electronic network 50, as will be appreciated by those skilled in the art.

In one embodiment, the electronic network 50 may be a wide area network (“WAN”), a local area network (“LAN”), an Intranet, or a wireless communications network. Preferably, the electronic network 50 may include several different types of networks, including, but not limited to, a WAN, a LAN, an Intranet, and/or a wireless network. For example, one such network including multiple different types of networks is the Internet, and more particularly the World Wide Web.

The server 40 is also connected to a voice communications network 60, for example, via a switch 70. The voice communications network 60 may be a telecommunications network, such as a public switched telephone network (PSTN). The switch 70 may include any variety of hardware components and/or software modules configured for connecting parties via the voice communications network 60. The members 10-n are also connected to the voice communications network 60, e.g., using conventional telephony equipment or computing devices (not shown), e.g., a telephone or the same computer or electronic device used to access the electronic network 50.

In a preferred embodiment, the members 10-n are participants in an online community, such as a general Internet service provider, or a specialized service provider, such as an online “singles” or dating service, or other online social community. The online community may be available to any interested persons and/or may involve payment of membership fees to participate. Thus, the members 10-n may include a variety of computer users having access to the electronic network 50, with access to the member database 44 being controlled by the operator of the server 40. The online community may include any number of members, as illustrated by member n.

When individual members join an online social community, they generally submit demographic or personal information about themselves. For example, they may submit information regarding their age, appearance (e.g., height, weight, eye color, hair color, etc.), where they live, their interests, hobbies, lifestyle, marital status, relationship preferences, and the like. This personal information may be submitted using any known method, for example, over a global electronic network, e.g., the Internet, over a telecommunications network, and the like. For example, the members may answer a series of questions using a web page interface or by completing hard copies of questionnaires.

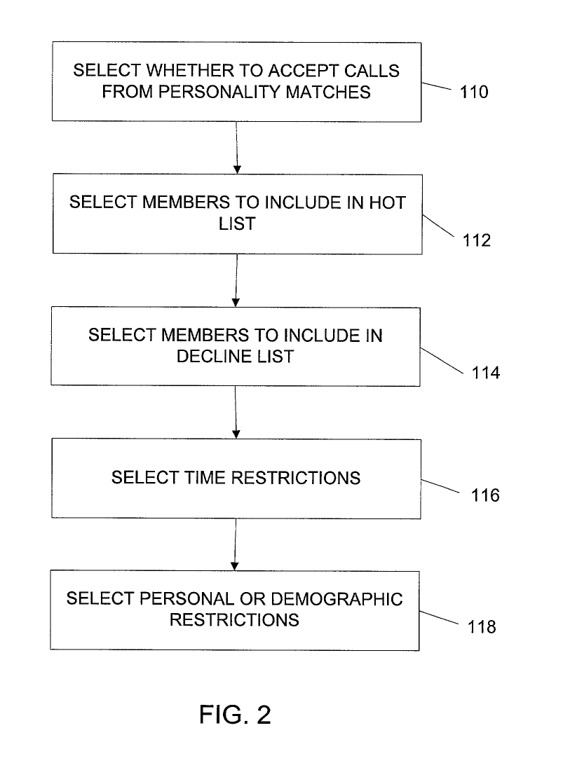

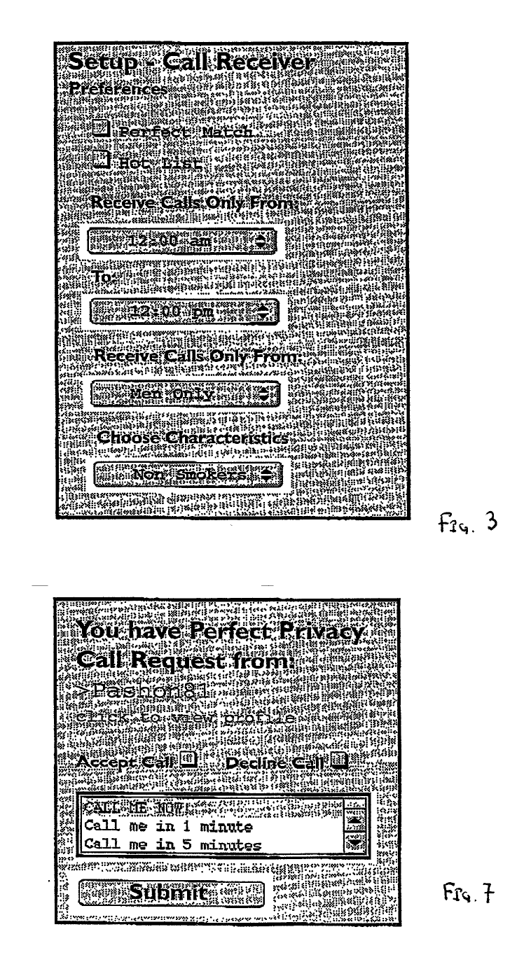

In addition, as shown in FIGS. 2 and 3, members also generally submit screening data related to their willingness to receive call requests, i.e., to initiate voice communications, from other members. Depending upon the structure of the online community, the individual members may first need to agree to provide screening data and/or to participate in the voice communication aspect of the online community when they join the community. Alternatively, the members may opt in or out of providing this information and participating at any time.

As shown in FIG. 3, a web page interface, including active icons and/or pull-down menus, may be used to facilitate submission of screening data, although other interfaces may also be used. With particular reference to FIG. 2, at step 110, members may select to accept calls only from members who match specific personality or personal profile parameters. For example, the online community may, upon members' requests or otherwise, use various statistical algorithms for searching the member database for members who may be compatible with other members. Exemplary systems and methods for performing such searches and matching based upon sociological archetypes are disclosed in application Ser. No. 09/688,455, filed Oct. 16, 2000, the disclosure of which is expressly incorporated herein by reference.

In addition, or alternatively, at step 112, members may select to accept call requests from a “Hot List” or other preferred lists of individual members. For example, members may at any time search the member database for members of interest, and then add these members to their Hot List. These searches may be performed based upon specific parameters selected by the searching member or based upon searching algorithms used by the online community, such as those described above. The Hot List may be exclusive, i.e., may include the only members from whom respective members are willing to receive call requests. Alternatively, the Hot List may provide a mechanism for notifying members when call requests are sent from members on their Hot List, as described further below.

In further alternatives, members may select not to be eligible for inclusion in other members' Hot Lists. For example, when a member selects another member for inclusion in their Hot List, a search may be conducted of the member profile of the member to be included to confirm whether or not the member has authorized themselves to be included in Hot Lists in general and/or in the Hot List of a specific member. In addition, members may request to be notified when they have been included in another member's Hot List or a notice may be sent at the request of the member creating the Hot List. These notices may be automatic or only upon authorization of one or both members.

At step 114, members may also select specific members from whom they do not want receive call requests, e.g., generating a “Decline List.”

At step 116, members may select time restrictions that limit when they will accept call requests. Members may select to receive calls only between particular hours, on particular days, and the like. For example, as shown in FIG. 3, a member may select only to receive calls from 10:00 a.m. to 11:00 p.m.

At step 118, members may select one or more personal or demographic parameters, e.g., such as member profile data included in the member database, to limit members from whom they will accept call requests. These parameters may be based upon sex, age, race, sexual orientation, marital status, habits (e.g., smoker v. non-smoker), interests, hobbies, and the like. For example, as shown in FIG. 3, a member may select only to receive call requests from men who are non-smokers. In addition, members may select geographic acceptance regions, e.g., within a predetermined geographic proximity to where they live, specific cities, counties, states, countries, and the like.

Optionally, members may also select whether they want other members to be able to access all or portions of their screening data. For example, members may want other members to know time restrictions when they will accept call requests, but may not want other members to know who is on their Hot List or Decline List.

Once members have selected their screening data, they may submit their screening data to the online community, e.g., to the server 40 in FIG. 1. The screening data for all participating members of the community may be compiled into a special screening database, a general member database, and/or other database, such as the database 44 shown generally in FIG. 1. For example, the screening data may be stored along with member profile data for the members in the member database 44. If the database 44 is searchable or accessible by members, all or portions of the screening data may be withheld, e.g., to maintain confidentiality of the members' screening preferences, either automatically or based upon respective members' preferences, as described above.

Members of the online community may then search the member database in order to seek out other members of the online community who may be of interest, e.g., sharing common interests and/or who may be compatible for personal relationships. Members may search for other members satisfying particular personal or demographic parameters, geographic location or proximity parameters, and the like. Alternatively or in addition, they may use statistical algorithms, such as those described above, to search for members with whom they may want to contact.

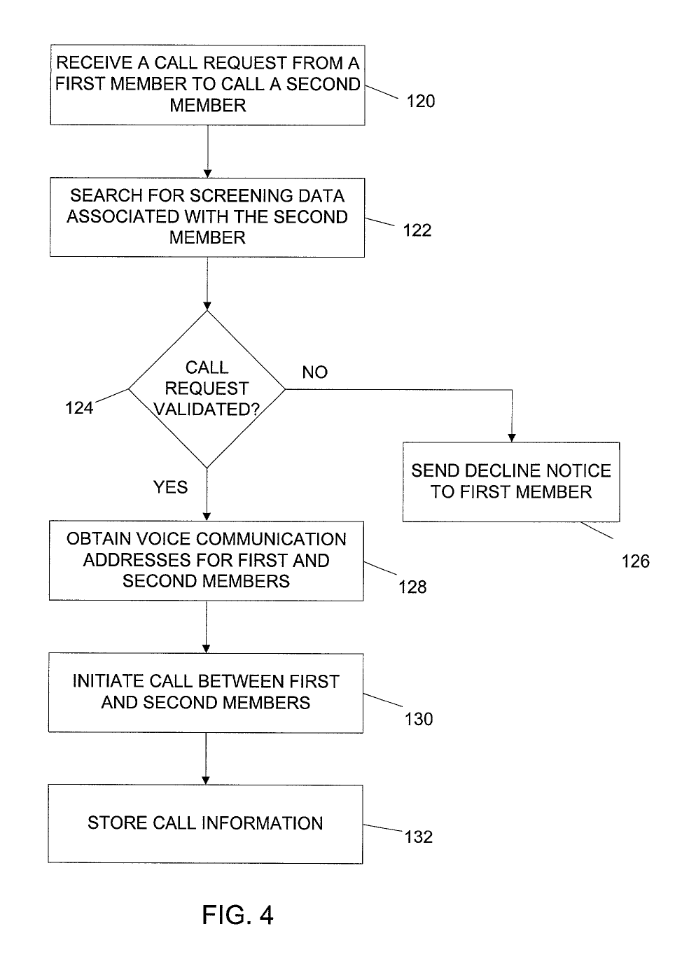

Once a member identifies another member with whom he/she is interested in contacting, he/she may initiate a request for voice communication, e.g., a telephone call, with the other member. An exemplary method for initiating such contact between a first member and a second member is shown in FIGS. 4-6. First, at step 120, the first member generates a “call request.” The call request generally includes member identifiers identifying the first and second members. In addition, the call request may include other information, such as personal contact information of the first member, e.g., a telephone number that should be used during the voice communication to contact the first member. The call request may also include a time of call, which may be the time at which the call request is sent by the first member or received by the server for immediate calls. Alternatively, the time of call may be a subsequent time at which the first member would like to begin the voice communication with the second member.

The first member may then submit the call request, which may be received, for example, by server 40 in FIG. 1. At step 122, the server 40 may search the member database or other database 44 including screening data associated with the second member.

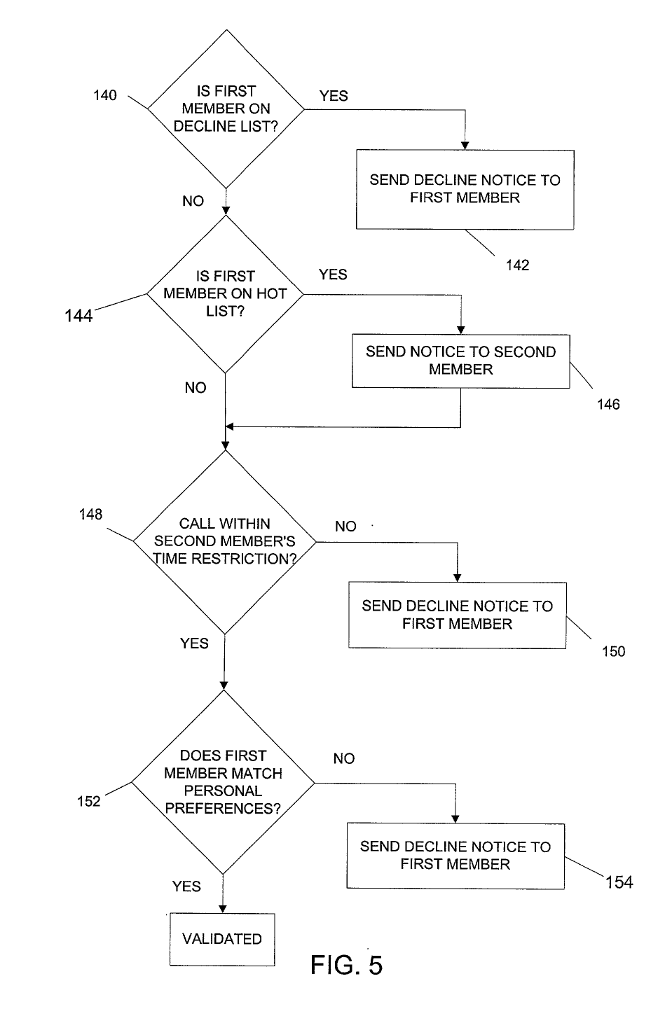

At step 124, the call request may be validated, for example, by the server 40. With particular reference to FIG. 5, at step 140, the server 40 may confirm whether the first member is included in the second member's Decline List. If so, at step 142, the server 40 may send a decline notice to the first member, and discontinue initiating the call. The decline notice preferably is a generic message, e.g., merely indicating that the second member is not accepting calls, although alternatively, the decline notice may inform the first member that the second member is not interested in receiving calls from him/her.

If the first member is not on the second member's Decline List, at step 144, the server 40 may check whether the first member is on the second member's Hot List. If so, at step 146, the server 40 may send a notice to the second member regardless of whether a call is ultimately connected. For example, the notice may inform the second member that a call request has been sent from someone on their Hot List. Alternatively, the server 40 may include a notice to the second member at the time the call is initiated, as described below.

At step 148, the server 40 may compare a time of call with a time restriction included in the second member's screening data. If the time of call is not within the authorized time restriction, at step 150, the server 40 may send a decline notice to the first and member and discontinue initiating the call. As above, the decline notice may be generic, simply informing the first person that the second member is not accepting calls. Alternatively, the notice may include additional information, e.g., informing the first member of the second member's time restriction or suggesting that the first member try again another time when the second member is available.

If the time of call falls within the second member's time restriction, the server 40 may then confirm whether the first member matches any personal or demographic parameters included in the second member's screening data. For example, the server 40 may search the member database for personal or demographic data in the member profile associated with the first member and compare this data with the parameters specified in the screening data associated with the second member. If the second member has selected that they only receive call requests from members matching a compatibility algorithm, the server 40 may automatically run the compatibility algorithm, e.g., comparing personal or demographic information of the first and second member's. Alternatively, the second member may have selected a geographic proximity restriction, within which a residence location of the first member must fall. If the data does not satisfy the specified parameters, at step 154, a decline notice is sent to the first member, which may be a generic message as described above.

It will be appreciated by those skilled in the art that these validation steps may be performed in any order, and that fewer than all or additional validation steps may be performed when validating a call request. In addition, a system in accordance with the present invention may include multiple hardware components and/or software modules for performing one or more of these steps. These components may be provided in a single device, such as the server 40 described above, or may be provided using multiple devices coupled directly to one another and/or communicating via the electronic network 50.

Returning to FIG. 4, if the call request is validated, at step 130, a call is initiated between the first and second members, e.g., using the switch 70 shown in FIG. 1. The switch 70 may include one or more devices for initiating communications between parties via the voice communications network 60. For example, U.S. Pat. Nos. 5,818,836 and 6,148,067, the disclosures of which are expressly incorporated herein by reference, disclose systems that may be used to provide such voice communications between members. The voice communication may simply be a telephone call between the members, e.g., via a telecommunications network, such as the PSTN. Alternatively, other voice communications networks may be used, such as Internet voice chat systems, as are known to those skilled in the art.

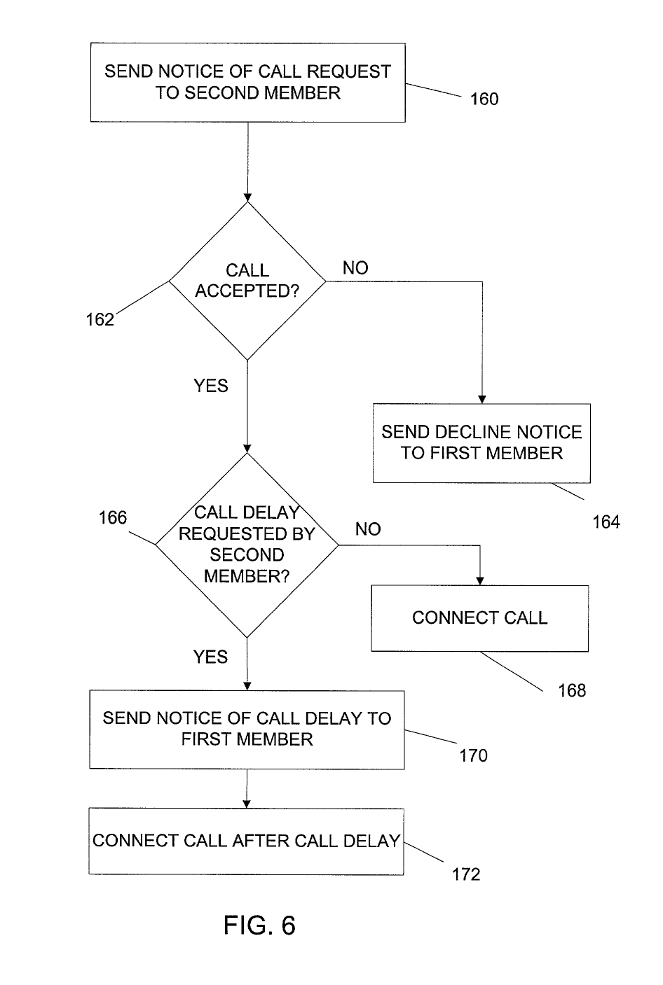

With particular reference to FIG. 6, a method for initiating a call between first and second members is shown. At step 160, a call notice may be sent to the second member that a call request has been sent from the first member. As shown in FIG. 1, the notice may be submitted via the electronic network 50 from the server 40, e.g., to the second member's computer. The notice may take the form of a web page, such as that shown in FIG. 7. Alternatively, the notice may be a voice communication, e.g., a recording, sent via a telecommunications network.

Generally, the notice includes a member identifier identifying the first member. The notice may include an interface, such as a “View Profile” icon, as shown in FIG. 7. If the “View Profile” icon is selected by the second member, the server 40 may retrieve personal and/or demographic data associated with the first member from the member database 44, and send it to the second member's computer for review. Alternatively, the notice may automatically include some or all of the member profile data associated with the first member, a photograph of the first member, and/or other information to assist the second member in deciding whether to accept the call. In addition, the notice may also inform the second member if the first member is on the second member's Hot List or satisfies a compatibility match.

If the notice is a voice message communicated via a telecommunications network, the switch 70 may call the second member and play a recording announcing that are about to be connected to a caller. The switch 70 may then call the first member if the first member is not already connected to the line. Alternatively, the recording may allow the second member to accept or decline the call, e.g., by pushing particular buttons on their telephone.

Returning to FIG. 6, at step 164, if the second member declines to accept the call, a decline notice is sent to the first member, which may be a generic message, as described above, and the call may be discontinued. If the second member agrees to accept the call, he/she may decide whether to request a call delay at step 166. For example, as shown in FIG. 7, the second member may decide to accept the call immediately, or delay accepting the call for a predetermined time, e.g., one or five minutes. This call delay option may be particularly useful for members that have a single line that is used to access both the electronic network and the voice communications network, e.g., a telephone line for placing and receiving telephone calls.

If the second member agrees to accept the call immediately, at step 168, the switch 70 may connect the first and second members via the voice communications network 60. To accomplish this, the switch 70 may request voice communication addresses, e.g., telephone numbers, from the server 40. The server 40 may retrieve the addresses from the member database 44 and send the addresses to the switch 70. Alternatively, if the call request includes a voice communication address for the first member, the server 40 may only need to retrieve the voice communication address for the second member from the member database 44. In a further alternative, the notice of acceptance from the second member may include a voice communication address, e.g., telephone number, at which to call the second member. In yet another alternative, the server 40 may acquire the members' voice communication addresses automatically during validation of the call request. Thus, the voice communication addresses for the first and second members may be actively submitted in the call request ad/or notice of acceptance, or may be automatically embedded therein.

If the second member requests a call delay, at step 170, the server 40 may send a delay notice to the first member. The notice may allow the first member to accept the delay or decline the delay and discontinue the call. At step 172, after the agreed upon call delay, a call between the first and second members may be connected, as described above.

If no response is received from the second member in response to the call notice, and consequently a call is not connected, or if the call fails to connect for any reason, the server 40 may send a notice to the second member that an attempted call was made. Thus, the second member may receive notice of missed calls, and may, if interested, try to initiate a call with the first member using the system, as described above. Optionally, the notice may include an automatic call-back feature, possibly bypassing one or more of the validation steps described above. The missed call notice may also include a time restriction from the first member, thereby informing the second member when to activate the call-back to the first member.

As an additional feature, the switch 70 and/or server 40 may track the voice communication between the first and second members, e.g., to record the duration of the call, the names of the members, their voice communication addresses, the time of call, and/or other information, e.g., which may be useful for billing purposes.

As a security feature, the call request and/or other communications used to implement the call request may be embedded with security algorithms and/or community identifiers, e.g., the domain name of the community or other security codes. Thus, the server 40 may be restricted only to process call requests and connect calls that originate from an authorized user.

A system in accordance with the present invention may facilitate anonymous voice communications between members of an online community. Because the members may submit screening data in advance of receiving any call requests, they may filter out calls from members with whom they are likely not to be interested in talking. While a system in accordance with the present invention also allows members to decline call requests when they receive them, the validation methodology provides an additional level of control, privacy, and automatic filtering. This may reduce the number of wasted calls that members may receive.

In addition, a system in accordance with the present invention may automatically retrieve telephone numbers or other personal contact information of the members from a member database and connect the members. Thus, the system may be more convenient than prior art systems that require communicating parties to submit telephone numbers, match codes, and/or other information with each call before the call is connected.

It will also be appreciated by those skilled in the art that multiple parties may engage in voice communications using the systems and methods of the present invention. For example, a call request from a first member may identify two or more other members. The call request may be validated with respect to all of the identified members, and all or some of the members may then be connected via the voice communications network, depending upon the preferences of the members. While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A method for initiating voice communication between first and second members of an online community using a member database comprising identities of members and screening data associated with respective members, the screening data comprising parameters selected by the respective members regarding to incoming voice communications from other members, the method comprising:
receiving a call request from the first member, the call request identifying the second member;
searching the member database for screening data associated with the second member;
validating the call request based upon the screening data associated with the second member; and
initiating voice communication between the first and second members, while withholding personal contact information of the first and second members from each another.

2. The method of claim 1, wherein the member database further comprises member profiles of respective members, wherein the screening data comprises profile preferences of respective members, and wherein the validating step comprises comparing profile preferences of the second member with a member profile of the first member.

3. The method of claim 2, wherein the step of initiating voice communication only occurs when the step of comparing profile preferences results in a predetermined compatibility match.

4. The method of claim 1, wherein the member database comprises geographic location data of respective members, wherein the screening data comprises geographic restriction data, and wherein the validating step comprises confirming that geographic location data of the first member is a subset of geographic restriction data associated with the second member.

5. The method of claim 1, wherein the screening data comprise decline lists comprising one or more members with whom respective members refuse to engage in voice communication, and wherein the validating step comprises confirming that the first member is not included in a decline list associated with the second member.

6. The method of claim 1, wherein the screening data comprise preferred member lists comprising one or more members with whom respective members are interested in engaging in voice communication, and wherein the validating step comprises confirming whether the first member is included in a preferred member list associated with the second member.

7. The method of claim 6, further comprising sending a notice to the second member when it is confirmed that the first member is included in the preferred member list associated with the second member.

8. The method of claim 1, wherein the screening data comprise time restrictions, and wherein the validating step comprises confirming whether a time of call for the call request falls within a time restriction associated with the second member.

9. The method of claim 8, wherein the call request comprises a desired time of call, and wherein the step of initiating voice communication comprises automatically initiating the voice communication at the desired time of call.

10. The method of claim 8, wherein the time of call comprises a time when the call request is received from the first member, and wherein the initiating step comprises immediately initiating voice communication upon validation of the call request.

11. The method of claim 1, wherein the step of initiating voice communication comprises sending a call notice to the second member, the call notice comprising an identifier identifying the first member, and a request to accept the voice communication.

12. The method of claim 11, wherein the step of initiating voice communication further comprises:
receiving an acceptance from the second member; and
connecting the first and second members via a voice communications network.

13. The method of claim 12, wherein the acceptance comprises a requested call delay, and wherein the first and second members are connected via the voice communications network after the requested call delay.

14. The method of claim 11, wherein the step of initiating voice communication further comprises:
attempting unsuccessfully to connect the voice communication between the first and second members; and
sending a missed call notice to the second member, the missed call notice comprising information related to the attempted voice communication.

15. The method of claim 14, wherein the missed call notice comprises a call-back interface, and wherein the method further comprises initiating voice communication from the second member to the first member when the second member selects the call-back interface.

16. The method of claim 11, wherein the call notice further comprises member profile data associated with the first member.

17. The method of claim 11, wherein the step of initiating voice communication further comprises sending member profile data associated with the first member to the second member.

18. The method of claim 1, wherein the step of initiating voice communication comprises:
obtaining the voice communication address for at least one of the first and second members from the member database; and
connecting the first and second members at locations identified by the voice communication addresses via a voice communications network.

19. A method for initiating a voice communication between a first member of an online community and other members of the online community, the method comprising:
submitting a search request to a server system having access to a member database, the search request comprising one or more profile parameters;
receiving a list of member identifiers from the server system, each of the member identifiers identifying members at least partially matching the one or more profile parameters;
submitting a call request to the server system for validation, the call request comprising a member identifier of a second member included in the list of member identifiers; and
receiving an acknowledgement from the server system whether the second member is willing to receive voice communications from the first member.

20. The method of claim 19, further comprising being connected to the second member via a voice communications network upon validation of the call request.

21. The method of claim 19, wherein the acknowledgement comprises receiving a telephone call from the network, the telephone call being connected to the second member.

22. The method of claim 19, wherein the acknowledgement comprises receiving a notice of a requested call delay requested by the second member.

23. The method of claim 22, further comprising being connected to the second member via a voice communications network after the requested call delay.

24. The method of claim 19, wherein the acknowledgement comprises a decline notice that the second member is unwilling to accept the call request.

25. The method of claim 24, wherein the decline notice comprises a time restriction notice indicating that the second member is not accepting the call notice because it falls outside a time restriction associated with the second member.

26. A system for providing anonymous voice communication between members of an online community, comprising:
a member database comprising member identifiers identifying members of the online community including first and second members and screening data associated with respective members, the screening data comprising parameters selected by the respective members regarding to incoming voice communications from other members;
an interface for receiving a call request from the first member, the call request identifying the second member;
a validation module for reviewing screening data of the second member to confirm authorization from the second member to receive a voice communication from the first member; and
a switch connectable to a voice communications network, the switch configured for initiating voice communication between the first and second members via the voice communications network after the call request has been validated by the validation module.

27. The system of claim 26, wherein the member database further comprises voice communication addresses associated with respective members, and wherein the switch is configured for receiving voice communication addresses of the first and second members from the member database, the switch configured for initiating voice communication between the voice communication addresses of the first and second members.

28. The system of claim 26, wherein the member database further comprises geographic location data of respective members, wherein the screening data comprises geographic restriction data, and wherein the validation module is configured for confirming that geographic location data of the first member is a subset of geographic restriction data associated with the second member.

29. The system of claim 26, wherein the screening data comprise decline lists comprising one or more members with whom respective members refuse to engage in voice communication, and wherein the validation module is configured for confirming that the first member is not included in a decline list associated with the second member.

30. The system of claim 26, wherein the screening data comprise preferred member lists comprising one or more members with whom respective members are interested in engaging in voice communication, and wherein the validation module is configured for confirming whether the first member is included in a preferred member list associated with the second member.

31. The system of claim 30, wherein the switch is configured for sending a notice to the second member if the first member is included in the preferred member list associated with the second member.

32. The system of claim 26, wherein the screening data comprise time restrictions, and wherein the validation module is configured for confirming that a time of call for the call request does not violate a time restriction associated with the second member.

33. The system of claim 32, wherein the call request comprises a desired time of call, and wherein the switch is configured for automatically initiating the voice communication at the desired time of call.

34. The system of claim 32, wherein the time of call comprises a time occurring when the call request is sent or received from the first member, and wherein the switch is configured for immediately initiating the voice communication upon confirmation by the validation module.

35. The system of claim 26, wherein the interface is configured for receiving a search request from a first member searching for other members satisfying one or more profile parameters included in the search request, the interface configured for communicating a list to the first member, the list comprising one or more member identifiers identifying members at least partially matching the profile parameters.

36. The system of claim 35, further comprising a search engine for searching member profile data of the member database for members satisfying search requests.

37. The system of claim 35, wherein the profile data comprises demographic data associated with respective members, and wherein the profile parameters comprise one or more demographic parameters.

38. The system of claim 26, wherein the interface comprises a server computer connected to the member database.

39. The system of claim 38, wherein the server computer is configured for extracting voice communication addresses from the member database to satisfy authorized call requests, and wherein the switch is connected to the server computer for receiving the extracted voice communication addresses.

40. The system of claim 39, wherein the server computer is configured for sending a call notice to the second member when the call request is validated, the call notice comprising an identifier identifying the first member, and a request to accept the voice communication.

41. The system of claim 40, wherein the server computer is configured for receiving an acceptance from the second member, the server computer configured for instructing the switch to connect the first and second members via a voice communications network upon receiving the acceptance.

42. The system of claim 26, wherein the switch comprises a telephony switch connected to a telecommunications network for connecting the voice communication between the first and second members via the telecommunications network.
